(19) United States
(12) Patent Application Publication
(10) Pub. No.: US 2022/0126545 A1
(43) Pub. Date: Apr. 28, 2022

(54) WINDOW FILM STRUCTURE FOR COOLING AND HEATING

(71) Applicant: Il Ho CHOI, Jeollabuk-do (KR)

(72) Inventor: Il Ho CHOI, Jeollabuk-do (KR)

(21) Appl. No.: 14/916,996

(22) PCT Filed: Dec. 29, 2015
(86) PCT No.: PCT/KR2015/014436

§ 371 Date: Mar. 15, 2018

(30) Foreign Application Priority Data
Feb. 25, 2015 (KR) 10-2015-0026669

(51) Int. Cl. B32B 3/12; E06B 9/24

(52) U.S. Cl. CPC B32B 3/12; E06B 9/24; B32B 2419/00; B32B 2307/732; E06B 2009/2482; B32B 2307/402; B32B 2307/304; B32B 2605/006; E06B 2009/2417; B32B 2307/412

(57) ABSTRACT

A window film structure for cooling and heating is disclosed. The window film structure for cooling and heating according to the present invention comprises: a front side film which is attached to a window through an adhesive layer provided at one side surface of the front side film; a back side film; a lattice plate which is provided between the front side film and the back side film and includes a number of transverse members and a number of longitudinal members which are combined along the lengthwise direction of the transverse members; and a first cover, a second cover, a third cover and a fourth cover which seal the lattice plate by being attached along the circumference of the lattice plate, wherein the front side film and the back side film have the thickness of 0.1˜10 mm, are transparent or semi-transparent, and are tinting processed.

### BACKGROUND

### (a) Technical Field

The present invention relates to a film structure and, more particularly, to a window film structure for cooling and heating.

### (b) Background Art

It is a trend that a super high apartment, a residence-store complex apartment, in particular, buildings for business which are recently new built are finished with a glass in their entire or most outer wall to make the appearance beautiful and to secure a view at the same time.

The glass has advantages of improving the appearance in the building and of making the building have various shapes, however, also has disadvantages. That is, the glass has low adiabatic rate so as to increase the energy consumption compared to a concrete wall, and accordingly, the more the glass is used, the more the sunscreen for screening the sun ray such as a curtain, vertical, roll screen, blind, etc. are necessary, so that the relevant cost is required.

In particular, the glass not only receives a hot direct layer of light from the sun as they are but also make the heat in a room to flow out as they are so that it is one of main causes of energy loss in the building.

That is, the heat in the room flows out to the outside as they are due to the glass in winter so as to increase the heating cost and the heat of the outside flows into the room as they are through the glass in summer so as to act as one of causes of increasing the cooling cost.

Accordingly, it is the trend that a single (or single layer) window glass is changed into a fold (or double layers) of window glasses. However, the double layer window glass has relatively higher adiabatic effect and sound insulation effect compared to the conventional single layer window glass to a certain degree, however, there is a structural problem in that the adiabatic effect of the level of target is difficult to anticipate.

### SUMMARY OF THE DISCLOSURE

The present invention has been made in an effort to solve the above-described problems associated with the prior art described above and an object of the present invention is to provide a window film structure for cooling and heating wherein a hot direct layer of light from the sun is interrupted by the window film structure for cooling and heating so that the direct layer of light flowing into a room is reduced.

Another object of the present invention is to provide a window film structure for cooling and heating wherein the energy loss in the building can be reduced by preventing an outflow of the heat in the room to the outside by the window film structure for cooling and heating.

Another object of the present invention is to provide a window film structure for cooling and heating wherein, at the time of applying it to the vinyl house, the outflow of the heat in the vinyl house to the outside can be reduced in winter, and the inflow of the heat of the outside into the room through the vinyl house can be reduced in summer.

Another object of the present invention is to provide a window film structure for cooling and heating which can also be used as a buffer which protects a product when the window film structure is formed in a vinyl type.

To accomplish the above described objects of the present invention, a window film structure for cooling and heating is provided which comprises: a front side film which is attached to a window through an adhesive layer provided at one side surface of the front side film; a back side film; a lattice plate which is provided between the front side film and the back side film and includes a number of transverse members and a number of longitudinal members which are combined along the lengthwise direction of the transverse members; and a first cover, a second cover, a third cover and a fourth cover which seal the lattice plate by being attached along the circumference of the lattice plate.

In the present invention, the front side film and the back side film are transparent or semi-transparent.

In the present invention, the front side film and the back side film are tinting processed.

In the meantime, to accomplish the above described objects of the present invention, a window film structure for cooling and heating is provided which comprises: a front side film which is attached to a window through an adhesive layer provided at one side surface of the front side film; a back side film; a lattice plate which is provided between the front side film and the back side film and includes a number of transverse members and a number of longitudinal members which are combined along the lengthwise direction of the transverse members; and a first cover, a second cover, a third cover and a fourth cover which seal the lattice plate by being attached along the circumference of the lattice plate, wherein the back side film, the first to fourth covers, and the lattice plate are integrally formed in a mold and are attached to other side of the front side film.

In the present invention, the integral formed product including the back side film, the first to fourth covers, and the lattice plate can be provided as a multi-layer structure at the other side of the front side film.

### EFFECT OF THE PRESENT INVENTION

According to the window film structure for cooling and heating of the present invention described above, there are effects as follows:

First, the window film structure for cooling and heating does not require a separate fold (or double layers) of window glasses, and if the window film structure is attached to the glass window, a hot direct layer of light from the sun is interrupted by the window film structure for cooling and heating so that the direct layer of light flowing into a room is reduced.

Second, the energy loss in the building can be reduced by preventing an outflow of the heat in the room to the outside by the window film structure for cooling and heating.

Third, at the time of applying it to the vinyl house, the outflow of the heat in the vinyl house to the outside can be reduced in winter, and the inflow of the heat of the outside into the room through the vinyl house can be reduced in summer.

Fourth, the window film structure can also be used as a buffer which protects a product when the window film structure is formed in a vinyl type.

### BRIEF DESCRIPTION OF THE DRAWINGS

FIG. 1 is a perspective view of a window film structure for cooling and heating according to an embodiment of the present invention;

FIG. 2 is an exploded perspective view of the window film structure for cooling and heating according to the present invention;

FIG. 3 is a partial enlarged view of the window film structure for cooling and heating according to the present invention;

FIG. 4 is an exploded perspective view showing the constitution of a lattice in the window film structure for cooling and heating according to the present invention; and

FIG. 5 is a front view of the window film structure for cooling and heating according to the present invention.

### DETAILED DESCRIPTION

Hereinafter, a window film structure for cooling and heating according to a preferable embodiment of the present invention will be described in detail.

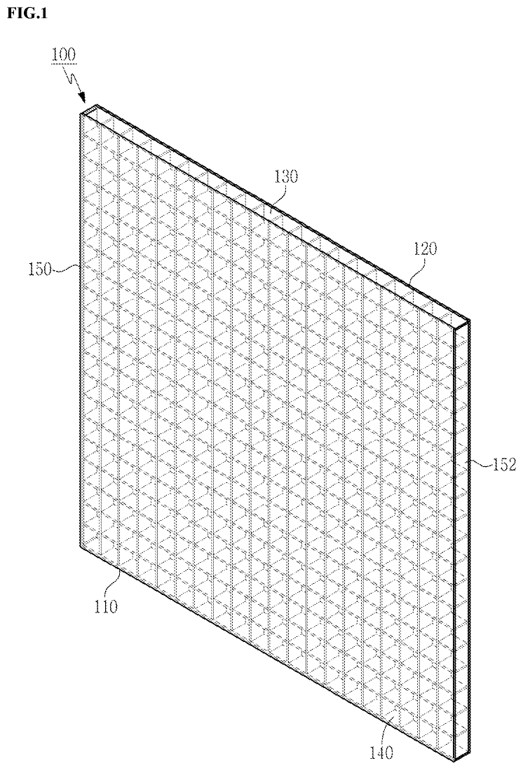

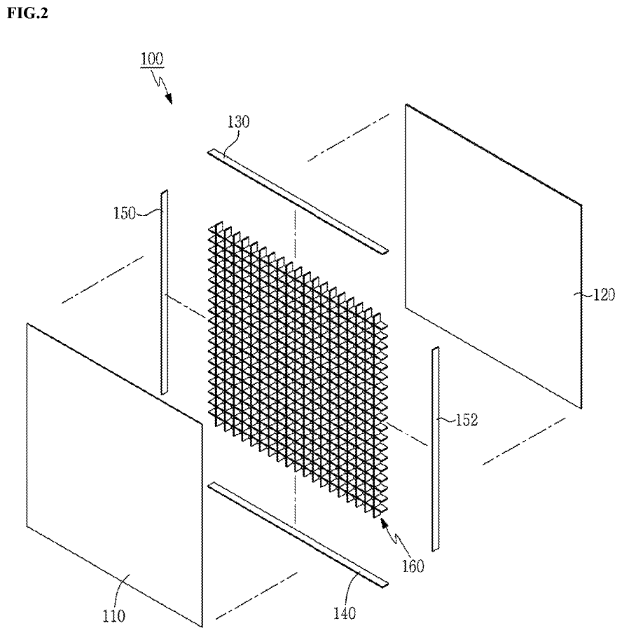

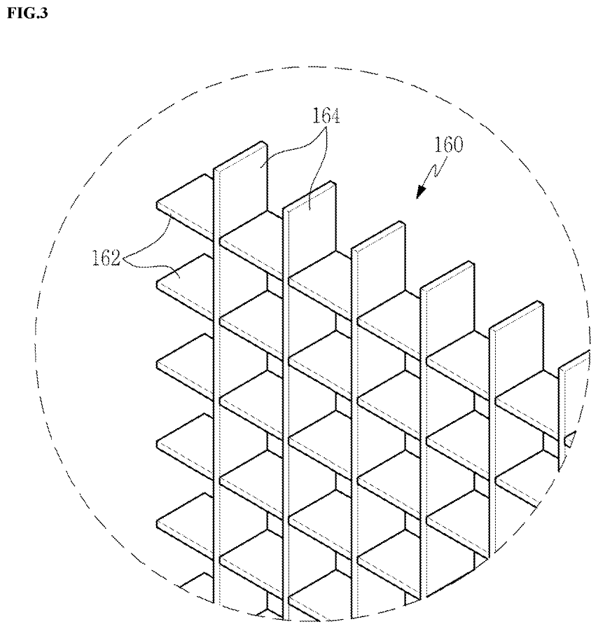

FIG. 1 is a perspective view of a window film structure for cooling and heating according to an embodiment of the present invention, FIG. 2 is an exploded perspective view of the window film structure for cooling and heating according to the present invention, and FIG. 3 is a partial enlarged view of the window film structure for cooling and heating according to the present invention.

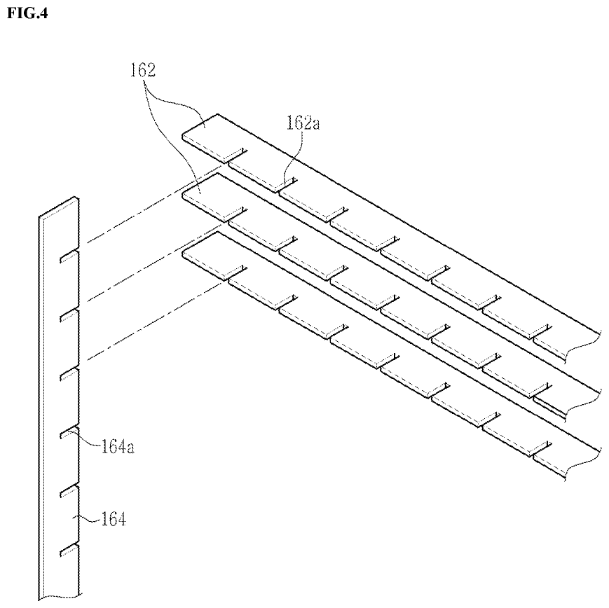

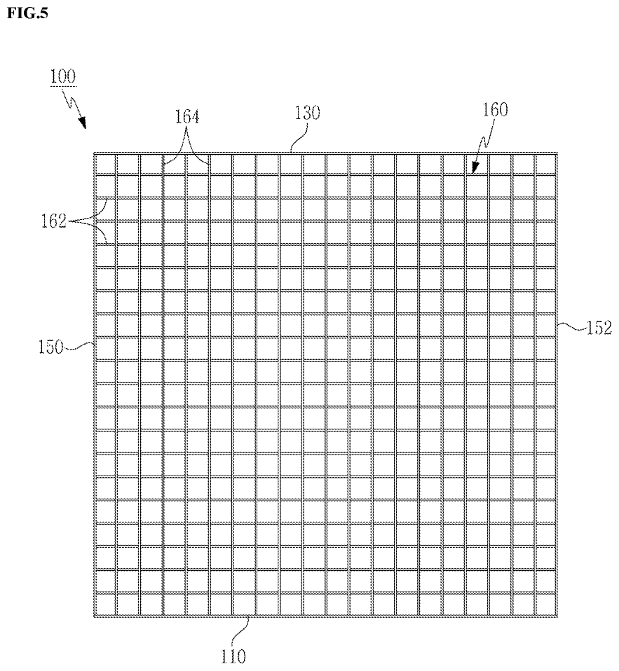

In addition, FIG. 4 is an exploded perspective view showing the constitution of a lattice in the window film structure for cooling and heating according to the present invention, and FIG. 5 is a front view of the window film structure for cooling and heating according to the present invention.

Referring to FIGS. 1 to 5, the window film structure for cooling and heating 100 according to the present invention largely comprises a front side film 110, a back side film 120, first to fourth covers 130, 140, 150, 152, and a lattice plate 160.

Referring to FIG. 2, the front side film 110 has predetermined sizes in a transverse direction and a longitudinal direction, and it is possible to appropriately select the size according to the size of a glass window of a place at which the glass window is to be installed, that is, the glass window of a building or the glass window of a vehicle.

Furthermore, the thickness of the front side film 110 can be appropriately selected within the range of 0.1˜10 mm according to the place at which the front side film 110 is to be installed.

In addition, it is possible to construct the front side film 110 transparent, as well as semi-transparent which can shade the light.

The front side film 110 is formed with an adhesive layer (not shown) at one side which will be attached to a window.

The back side film 120 has the thickness of 0.1˜10 mm together with the same transverse and longitudinal size as the front side film 110, and can be selectively constructed to be transparent or semi-transparent.

In addition, the front side film 110 and the back side film 120 can be tinting (another name, sunting) processed for protection of the privacy together with the ultraviolet and heat insulation effect.

Referring to FIGS. 2 to 4, the lattice plate 160 is provided between the front side film 110 and the back side film 120 and has the form in which the transverse member 162 and the longitudinal member 164 cross to each other. That is, insert recesses 162a and 164a having equal spacing along the lengthwise direction of the transverse member 162 and the longitudinal member 164 are respectively formed so that plural longitudinal members 164 are combined along the lengthwise direction of the transverse members 162.

Referring to FIG. 2, the window film structure comprises first to fourth covers 130, 140, 150, 152 which seal the lattice plate by being attached along the circumference of the lattice plate 160.

That is, referring to FIG. 2, the first cover 130 corresponds to an upper cover and seals the space between the front side film 110 and the back side film 120 by filling up the space at the upper part of the lattice plate 160.

The second cover 140 corresponds to a lower cover and seals the space between the front side film 110 and the back side film 120 by filling up the space at the lower part of the lattice plate 160.

The third cover 150 corresponds to a left cover and seals the space between the front side film 110 and the back side film 120 by filling up the space at the left part of the lattice plate 160.

The fourth cover 152 corresponds to a right cover and seals the space between the front side film 110 and the back side film 120 by filling up the space at the right part of the lattice plate 160.

The present invention having the above described structure respectively forms an adhesive layer (not shown) at respective interior side of the front side film 110 and the back side film 120 and respective interior side of the first to fourth covers 130, 140, 150, 152, and thereafter attach the lattice plate 160 where the transverse member 162 and the longitudinal member 164 are provided in the form of crossing to each other so that the lattice plate is interposed between the front side film 110 and the back side film 120.

Thereafter, the space between the front side film 110 and the back side film 120 are sealed by filling up the space by respectively attaching the above described first to fourth covers 130, 140, 150, 152 along the circumference of the lattice plate 160.

The window film structure for cooling and heating 100 prepared as such does not require a separate fold (or double layers) of window glasses, and if the window film structure is attached to the glass window through an appropriate attaching means (for example, double side tape), a hot direct layer of light from the sun is interrupted by the window film structure for cooling and heating 100 so that the direct layer of light flowing into a room is reduced.

In addition, by preventing an outflow of the heat in the room to the outside by the window film structure for cooling and heating 100, the energy loss in the building can be reduced.

That is, the cost of heating can be reduced by reducing the outflow of the heat in the room to the outside due to the glass in winter, and the rise of the cost of cooling can be reduced by reducing the inflow of the heat of the outside into the room through the glass in summer.

In the meantime, the present invention has been described by taking the glass window, that is, the window as an example, it is not necessarily limited thereto but can be applied to a vinyl house. That is, in case where the front side film 110 and the back side film 120 are substituted by a front side vinyl and a back side vinyl, the lattice plate 160 is interposed between the first to fourth covers 130, 140, 150, 152, the outflow of the heat in the vinyl house to the outside can be reduced in winter, and the inflow of the heat of the outside into the room through the vinyl house can be reduced in summer.

At this time, the thickness of the front side vinyl and the back side vinyl can be selected to be 0.5˜10 mm, and can be selectively constructed to be transparent or semi-transparent.

In addition, the window film structure can be used for the usage as a buffer agent which protects the product at the time of forming it in the vinyl type. That is, the conventional air cap (another name, ppokppokyi) is opened at its sides so as not to completely interrupt the air so that the effect of heat preservation is reduced, however, at the time of applying the present invention, since each compartment is interrupted, even if any one compartment is broken, it does not influence other compartment so that the heat preservation effect is large.

In addition, in the present invention, the lattice plate 160 appeared to have a form in which the transverse member 162 and the longitudinal member 164 cross each other, however, the lattice plate is not necessarily limited thereto, but it is possible to construct other forms such as circular form, as well as triangular form, rectangular form, and hexagonal form as the lattice plate.

In the meantime, referring to FIG. 2, the front side film 110, the back side film 120, the first to fourth covers 130, 140, 150, 152, and the lattice plate 160 are respectively separated, however, they are not necessarily limited thereto.

That is, it is possible that the back side film 120, the first to fourth covers 130, 140, 150, 152, and the lattice plate 160 are integrally formed in a separate mold, and thereafter, the integral formed product is attached to other side of the front side film 110 as one structure.

At this time, it is possible that the integral formed product including the back side film 120, the first to fourth covers 130, 140, 150, 152, and the lattice plate 160 is formed as a multi-layer structure, for example, 1˜5 layers at the other side of the front side film 110 according to the necessity.

Although the window film structure for cooling and heating according to the present invention has been described with reference to the exemplary shown drawings, it will be appreciated that the present invention is not limited to the embodiments and the drawings disclosed in the present specification but various transformations can be performed by those skilled in the art within the scope of the technical thoughts of the present invention.

What is claimed is:

1. A window film structure for cooling and heating comprising:
a front side film which is attached to a window through an adhesive layer provided at an outer side surface of the front side film and at an inner side surface of which is formed an adhesive layer;
a back side film which has the same size as the front side film and at an inner side surface of which is formed an adhesive layer;
a lattice plate which is provided between the front side film and the back side film and includes a number of transverse members and longitudinal members, wherein insert recesses having equal spacing along the lengthwise direction of the transverse member and the longitudinal member are respectively formed so that plural longitudinal members are combined along the lengthwise direction of the transverse members; and
a first cover, a second cover, a third cover and a fourth cover which fill up a space between the front side film and the back side film by being attached along the circumference of the lattice plate.

2. The window film structure of claim 1, wherein the front side film and the back side film have the thickness of 0.1˜10 mm and are transparent or semi-transparent.

3. The window film structure of claim 2, wherein the front side film and the back side film are tinting processed.
